(19) United States
(12) Patent Application Publication
(10) Pub. No.: US 2010/0041287 A1
(43) Pub. Date: Feb. 18, 2010

(54) GASKETED CONNECTION OF MARINE ENGINE EXHAUST OUTLET TO EXHAUST CONDUIT

(76) Inventors: Woodrow Woods, Riviera Beach, FL (US); Darrin Woods, Riviera Beach, FL (US)

Correspondence Address: MALIN HALEY DIMAGGIO BOWEN & LHOTA, P.A., 1936 S ANDREWS AVENUE, FORT LAUDERDALE, FL, 33316, US

(21) Appl. No.: 12/539,918

(22) Filed: Aug. 12, 2009

Related U.S. Application Data
(60) Provisional application No. 61/088,116, filed on Aug. 12, 2008.

(51) Int. Cl. B63H 21/00; F02B 33/44; B63H 21/32

(52) U.S. Cl. 440/89 R; 60/598

(57) ABSTRACT

A connecting flange comprises a generally open ended cylindrical body having an inlet adapted for receiving a gasket for providing a sealing connection with a turbocharger housing, and an outlet for connection to marine exhaust conduit. The connector inlet terminates in an end having a radially flared angularly disposed end wall adapted for mating abutting engagement with a correspondingly angled turbocharger housing end wall. The connector inlet end further includes circumferential axially recessed groove that receives spiral wound gasket in a configuration wherein the gasket forms redundant seals at a plurality of locations. The connector inlet structure cooperates with the turbo charger outlet structure to completely enclose the gasket thereby protecting the gasket from hot corrosive exhaust gases. A V-Band clamp is disposed in covering relation with the connector end wall and abutting turbocharger housing component to secure the connector to the turbocharger.

### CROSS-REFERENCE TO RELATED APPLICATIONS

This application claims the benefit of provisional U.S. Patent Application Ser. No. 61/088,116, filed on Aug. 12, 2008.

### STATEMENT REGARDING FEDERALLY SPONSORED RESEARCH OR DEVELOPMENT

N/A

### COPYRIGHT NOTICE

A portion of the disclosure of this patent document contains material that is subject to copyright protection. The copyright owner has no objection to the facsimile reproduction by anyone of the patent document or patent disclosure as it appears in the Patent and Trademark Office patent file or records, but otherwise reserves all copyrights.

### BACKGROUND OF THE INVENTION

1. Field of the Invention

The present invention relates generally to exhaust systems for internal combustion engines, and more particularly to a connecting flange and gasket configuration for use in connecting an exhaust conduit to the outlet of a marine engine turbocharger such that leakage of harmful exhaust gas is prevented.

2. Description of Related Art

Marine vessels are typically configured with a propulsion system having an internal combustion engine mounted internally within the vessel hull. Exhaust generated by the engine is commonly routed through exhaust conduit to the stem or rear of the vessel via one or more exhaust ducts and is discharged through one or more exhaust ports formed in the transom. In a large number of applications the exhaust is routed through a turbo charger that has an outlet in communication with an exhaust conduit.

A variety of structures are known in the background art for use in silencing marine exhaust noise. The present inventor has invented a number of novel marine exhaust components that have greatly improved the silencing and efficiency of marine exhaust systems. Among those inventions developed by the present inventor are: U.S. Pat. No. 4,918,917 for a Liquid Cooled Exhaust Flange; U.S. Pat. No. 5,196,655, for a Muffler for Marine Engines; U.S. Pat. No. 5,228,876, for a Marine Exhaust System Component comprising a heat resistant conduit; U.S. Pat. No. 5,262,600 for an In-line Insertion Muffler for Marine Engines; U.S. Pat. No. 5,444,196 for an improved In-line Insertion Muffler for Marine Engines; U.S. Pat. No. 5,504,280, for a Muffler for Marine Engines; U.S. Pat. No. 5,616,893, for a Reverse Entry Muffler With Surge Suppression Feature; U.S. Pat. No. 5,625,173, for a Single Baffle Linear Muffler for Marine Engines; U.S. Pat. No. 5,718,462 for Muffler Tube Coupling With Reinforcing Inserts; and U.S. Pat. No. 5,740,670, for a Water Jacketed Exhaust Pipe for Marine Exhaust Systems.

Providing an exhaust gas conduit system that routes engine exhaust gas from the engine safely from the vessel without leakage is important as the presence of exhaust gas in an engine compartment or otherwise on the vessel is an extremely dangerous, life threatening situation. Problems have been encountered in connecting exhaust conduit to the engine turbocharger outlet such that a leak proof seal is maintained. In accordance with the known prior art, connecting a turbocharger outlet to exhaust pipe typically involves reliance on press or compression fit between the turbocharger outlet and a metallic connector to from a gasket-less connection. Those connections, however, have proven susceptible to exhaust gas leakage that is believed to result largely from engine-induced vibrations that prevent the maintenance of a gas tight seal.

Accordingly, there exists a need for an improved connecting for use in mounting marine exhaust conduit to a marine engine turbocharger outlet so as to maintain a leak proof seal for preventing the escape of exhaust gas.

### BRIEF SUMMARY OF THE INVENTION

The present invention provides an improved connector and gasketed connection assembly particularly adapted for use in mounting marine exhaust conduit to a marine engine turbocharger outlet, so as form and reliably maintain a sealed leak proof connection. The connector comprises a generally open ended cylindrical body having an inlet adapted for receiving a gasket for providing a scaling connection with a turbocharger housing, and an outlet for connection to marine exhaust conduit. The connector inlet terminates in an end having a radially flared angularly disposed end wall adapted for mating abutting engagement with a correspondingly angled turbocharger housing end wall. The connector inlet end further includes circumferential axially recessed groove that receives spiral wound gasket in a configuration wherein the gasket forms redundant seals at a plurality of locations. The connector inlet structure cooperates with the turbo charger outlet structure to completely enclose the gasket thereby protecting the gasket from hot corrosive exhaust gases. A V-Band clamp is disposed in covering relation with the connector end wall and abutting turbocharger housing component to secure the connector to the turbocharger.

Accordingly, it is an object of the present invention to provide an improved leak-proof connector for marine exhaust conduit connections.

Another object of the present invention is to provide for connection of marine exhaust pipe to a marine engine turbocharger via a gasketed connection wherein the gasket is generally encased so as to be substantially protected from exposure to hot and corrosive exhaust gases.

In accordance with these and other objects that will become apparent hereinafter, the instant invention will now be described with particular reference to the accompanying drawings.

### BRIEF DESCRIPTION OF THE SEVERAL VIEWS OF THE DRAWINGS

FIG. 1 is a schematic illustration of a marine engine adapted with a turbocharger having an outlet connected to exhaust piping by a flange connector in accordance with the prior art;

FIG. 2 is a partial detail view thereof;

FIG. 3 is a perspective view of an exhaust conduit connecting flange in accordance with the present invention;

FIG. 4 is a partial detail view thereof;

FIG. 5 is an end view thereof;

FIG. 6 is a sectional view thereof;

FIG. 7 is an exploded perspective view of a turbocharger, exhaust duct connection flange and gasket in accordance with the present invention;

FIG. 8 is a partial detailed sectional view showing a turbocharger, exhaust duct connection flange and gasket in accordance with the present invention in a partially spaced relation; and

FIG. 9 is a partial detailed sectional view showing showing the turbocharger, exhaust duct connection flange, and gasket in connected relation secured by a V-band.

### DETAILED DESCRIPTION OF THE INVENTION

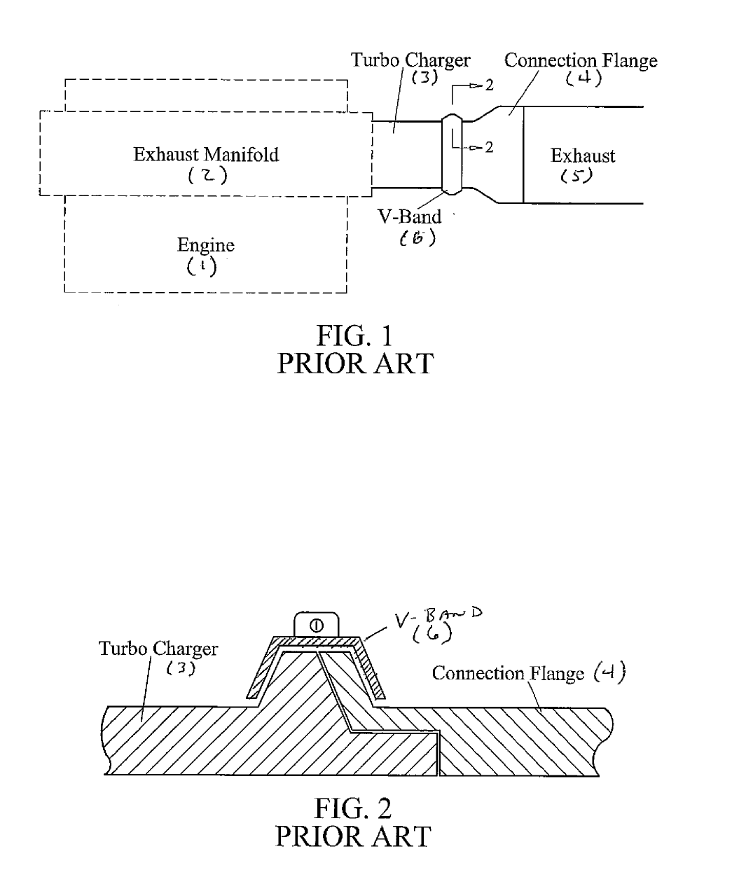

With reference now to the drawings, FIGS. 1 and 2 depict connection a marine engine turbocharger to exhaust duct using a connector in accordance with the prior art. A marine engine 1 has an exhaust manifold 2 connected to a turbocharger 3 which in turn is connected to a connection flange 4 of the type commonly used in the art to facilitate the attachment of exhaust duct or pipe 5. An annular V-band clamp 6 functions to secure turbocharger 3 to connection flange 4. FIG. 2 provides a detailed view illustrating abutting connection of turbocharger 3 to the prior art connection flange 4 using the V-band clamp 6. This prior art connection relics on a metal-to-metal press fit between the turbocharger and the connection flange secured by a V-band clamp to maintain a seal sufficient to prevent the hot and corrosive exhaust gas from leaking. As discussed above, a significant problem experienced in the connection of the turbo charger 3 and connection flange 4 is exhaust gas leakage that is believed to result from engine/turbocharger vibrations preventing the maintenance of a gas tight seal, particularly at the junction between the turbocharger outlet and the exhaust conduit.

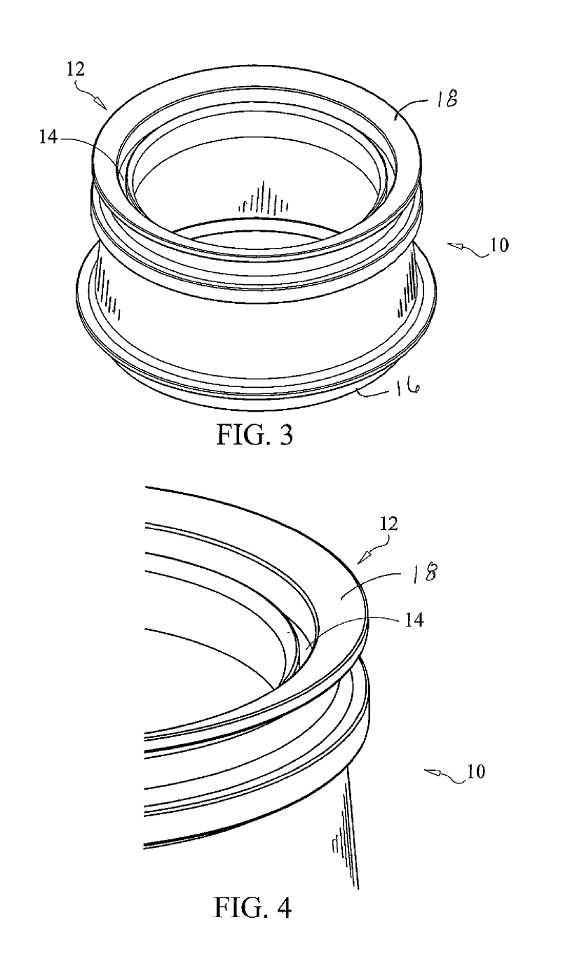

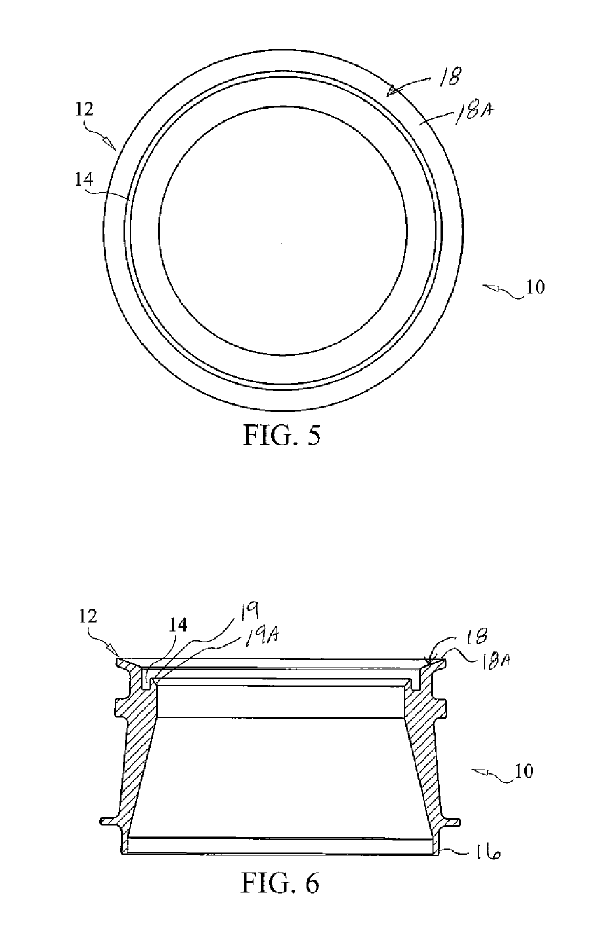

FIGS. 3-6 depict an improved exhaust pipe connector, generally referenced as 10, in accordance with the present invention. Connector 10 preferably comprises a metallic annular connection component for use in mounting marine exhaust conduit or pipe to a marine engine turbocharger outlet so as form, and reliably maintain, a sealed leak proof connection. Connector 10 comprises a generally open ended cylindrical or annular body and is preferably fabricated from corrosion resistant metal, metal alloy, or any other suitable material. Connector 10 defines a generally cylindrical inlet end, generally referenced as 12, having a recessed groove 14 for receiving a compression gasket that functions as a seal when connecting flange 10 is connected to a turbocharger outlet. Connector 10 further includes outlet end 16 for connection to marine exhaust conduit.

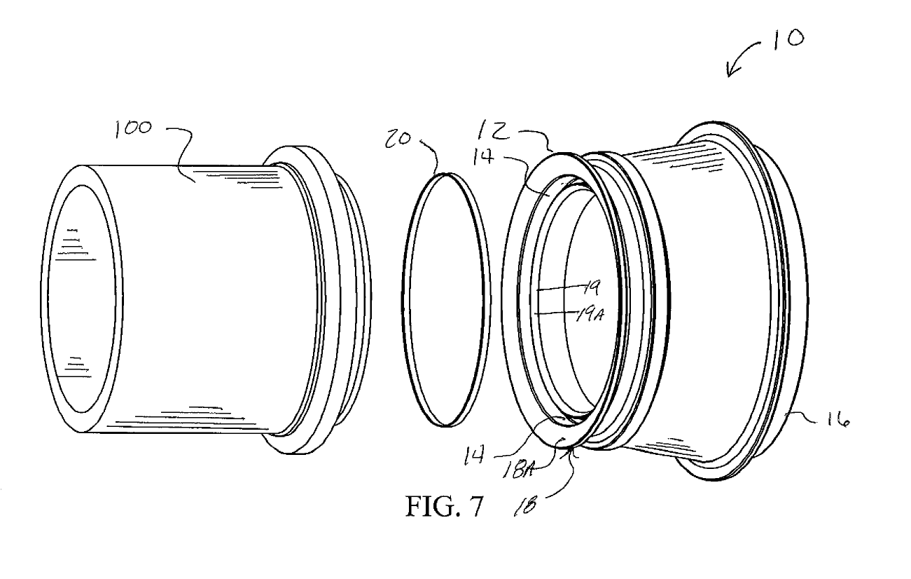

Connector inlet end 12 is specifically adapted for mating abutting engagement with a correspondingly turbocharger housing outlet. Connector inlet 12 includes a radially outer end wall projection 18 terminating in a converging annular end wall 18A at the circumferential outer edge of inlet 12, and a radially inner projection or lip 19 projecting in an axial direction in radially inward, generally parallel, spaced relation with end wall projection 18. Lip 19 includes a beveled surface 19A as seen in FIGS. 4, 6, 8 and 9. As best seen in FIG. 6, end wall 18A diverges from the inlet end 12 of connector 10. Providing lip 19 with a beveled surface 19A functions to aid in the alignment and mounting of connector 10 to the turbocharger. Recessed groove 14, defined at connector inlet end 12 of connecting flange 10 is concentrically bounded on opposing sides by the inner surface of outer end projection 18 and the outer surface of radially inner projection 19, and along a third side by an end wall disposed generally perpendicular to the axis of connector 10. Recessed groove 14 preferably receives a spiral wound gasket 20 as best illustrated in FIG. 7-9. Spiral wound gaskets are generally metal gaskets manufactured by wrapping alternating layers of thin stainless steel and soft gasket filler material such as graphite or PTFE. Spiral wound gaskets typically have a V-shaped profile that provides resilience and a “spring like” characteristic that enhances performance. A suitable gasket is available from Leader Global Technologies, Deer Park, Tex.

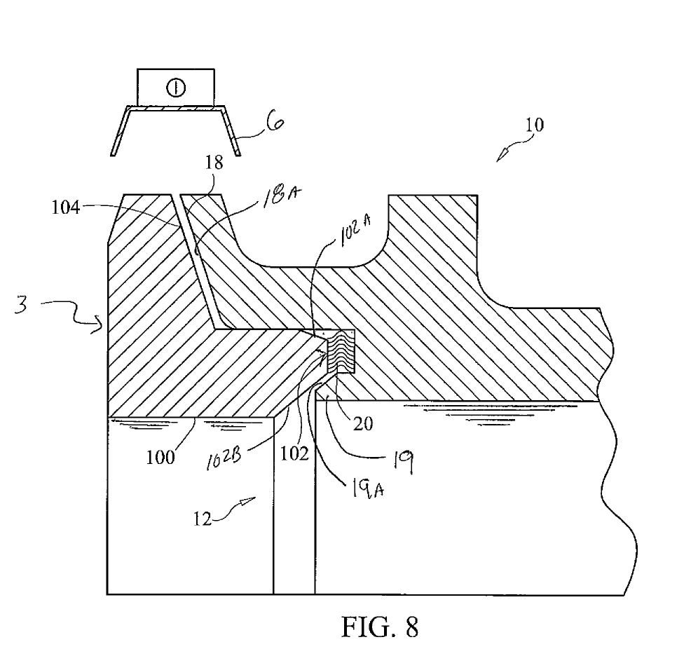

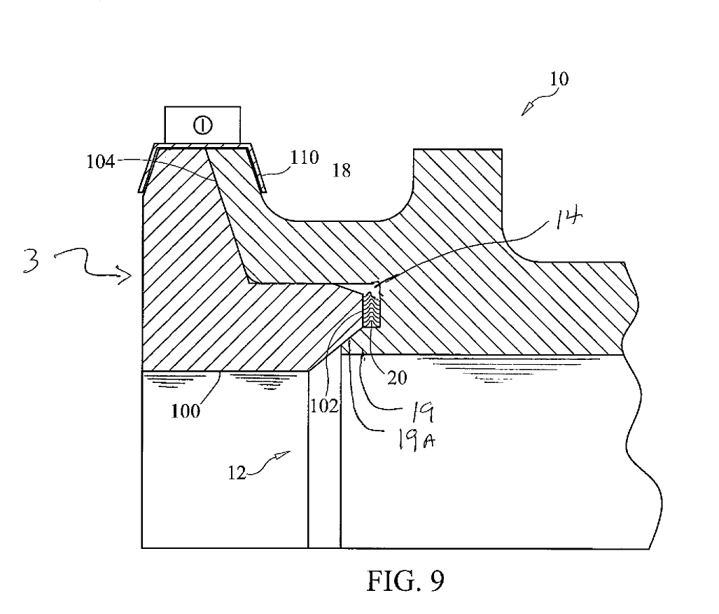

A significant aspect of the present invention involves: (1) the use of a gasket to form a seal in contrast to conventional non-gasket connections; (2) placing the gasket in a fully encased configuration; and (3) positioning the gasket such that the gasket makes redundant sealing contact at a plurality of locations. As best seen in FIGS. 8 and 9, gasket 20 is received within recessed groove 14 on the inlet end 12 of connector 10. Upon clamped connection of the connector inlet 12 with the outlet 100 of a turbocharger 3, gasket 20 is confined, compressed, and generally encased within the volume defined by recessed groove 14 and turbocharger outlet wall 102 as illustrated in FIGS. 8 and 9. Encasement of the gasket between a volume defined by the mating engagement of the turbocharger outlet and connector inlet is considered important to protect the gasket from the hot and corrosive mixture of exhaust gas and entrained cooling water. Turbocharger outlet wall 102 includes radially outer and inner beveled surfaces, referenced as 102A and 102B respectively. As noted above, connector 10 is provided with a 19 having a beveled surface 19A functions to aid in the axial alignment and mounting of connector 10 to the turbocharger. The confinement of gasket 20 within said volume further functions to maintain the gasket in place. The compression of gasket 20 results in redundant sealing contact in at least three, and preferably four locations, namely, along the all four bounding sides. In particular gasket 20 comes in sealing engagement with thee sides bounded by the wall defining recess 14, and the end wall 102 of the turbocharger housing. Providing redundant sealing contact at multiple points is considered important in view of the generally constant vibration transmitted to the connection from the engine.

As illustrated in FIGS. 8 and 9, a V-Band clamp 6 is used to secure connector inlet 12 to a turbocharger outlet such that end wall 18 is in abutting engagement with the turbocharger outlet, and particularly angled turbocharger outlet wall 104. More particularly, a V-band clamp 6 is disposed in covering relation with the connector end wall projection 18 and abutting turbocharger housing component to secure the connector to the turbocharger such that connector wall surface 18A and turbocharger wall 104 are in abutting engagement.

The instant invention has been shown and described herein in what is considered to be the most practical and preferred embodiment. It is recognized, however, that departures maybe made therefrom within the scope of the invention and that obvious modifications will occur to a person skilled in the art.

What I claim is:

1. A marine exhaust system connection assembly for mounting marine exhaust pipe to the outlet of a marine engine turbocharger to form leak resistant connection, said connection assembly comprising:
an annular connector having an inlet end and an outlet end;
said inlet end defining an annular recessed groove;
a spiral wound gasket received within said recessed groove;
a V-band clamp for coupling said annular connector to the turbocharger outlet such that said spiral would gasket is compressed and fully encased within a volume defined by surfaces of said annular connector and at least one surface of the turbocharger; and
said outlet end connected to marine exhaust pipe in a fluid-tight manner.

2. A marine exhaust system connection assembly according to claim 1 wherein said annular connector is fabricated from corrosion resistant material.

3. A marine exhaust system connection assembly according to claim 1 wherein said spiral wound gasket comprises alternating layers of thin stainless steel and soft gasket filler.

4. A leak resistant marine exhaust system connection assembly comprising:
a marine engine having a turbocharger, said turbocharger having an outlet;
an annular connector having an inlet end connected to said turbocharger outlet and an outlet end connected to exhaust pipe;
said connector inlet end defining an annular recessed groove;
a gasket received within said recessed groove;
a V-band clamp for coupling said annular connector to said turbocharger outlet such that said spiral would gasket is compressed and fully encased, whereby said spiral would gasket provides a positive seal between said connector and said turbocharger.

5. A marine exhaust system connection assembly according to claim 1 wherein said gasket is received within said recessed groove and generally encased within a volume formed by mating connection of said annular connector and said turbocharger.

6. A marine exhaust system connection assembly according to claim 1 wherein said gasket comprises a spiral wound gasket.

7. A marine exhaust system connection assembly according to claim 1 wherein said annular connector is fabricated from corrosion resistant material.

8. A marine exhaust system connection assembly according to claim 1 wherein said spiral wound gasket comprises alternating layers of thin stainless steel and soft gasket filler.
